(19) United States
(12) Patent Application Publication
(10) Pub. No.: US 2008/0278850 A1
(43) Pub. Date: Nov. 13, 2008

(54) MOTOR

(75) Inventors: Tomohiro YONEDA, Kyoto (JP); Keita HAMAKAWA, Kyoto (JP); Takayuki IWASE, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 11/965,924

(22) Filed: Dec. 28, 2007

(30) Foreign Application Priority Data
May 10, 2007 (JP) 2007-125573

(51) Int. Cl. F16C 32/06; G11B 17/02; H02K 7/08

(52) U.S. Cl. 360/99.08; 384/110; 310/90

(57) ABSTRACT

When a sleeve of a fluid dynamic bearing is manufactured, its inner peripheral surface is formed by cutting. On the inner peripheral surface, first and second inclined surfaces are formed by a first cutting process such that a distance between the sleeve and a central axis is increased toward an upper end surface of the sleeve. Then, an upper bearing surface and a third inclined surface between the upper bearing surface and the first inclined surface are formed on the inner peripheral surface of the sleeve by a second cutting process of accuracy higher than that of the first cutting process. In the second cutting process, it is possible to form accurately in position a boundary between the upper bearing surface and the third inclined surface in contact with an upper end of an upper dynamic pressure groove provided on the upper bearing surface.

### BACKGROUND OF THE INVENTION

1. Field of the Invention

The present invention relates to a sleeve of a fluid dynamic bearing and a manufacturing method thereof, a motor including the sleeve, and a disk drive.

2. Description of the Related Art

Conventionally, a disk drive such as a hard disk drive includes a spindle motor (hereinafter, simply referred to as “motor”) for rotationally driving a disk-shaped storage medium (hereinafter, simply referred to as “disk”), and adopts a fluid dynamic bearing utilizing a fluid dynamic pressure as one of motor bearing assemblies. In such a fluid dynamic bearing, a radial bearing portion is configured between an outer peripheral surface of a shaft and an inner peripheral surface in a substantially cylindrical shape of a sleeve for allowing the shaft to be inserted thereinto.

In a fluid dynamic bearing assembly of a motor described in Japanese Unexamined Patent Publication No. 2005-155689, there is formed an inclined surface in the vicinity of an upper end of a sleeve such that a gap between a shaft and the sleeve is made larger than a radial bearing portion. The gap between the inclined surface of the sleeve and an outer peripheral surface of the shaft functions as an oil buffer for retaining an extra lubricant filled between the shaft and the sleeve. In such a fluid dynamic bearing assembly, when an amount of the lubricant is decreased due to evaporation or the like, the lubricant retained in the oil buffer flows into the radial bearing portion formed below the oil buffer to prevent shortage in lubricant in the radial bearing portion and a thrust bearing portion.

With regard to the above-described fluid dynamic bearing assembly, there is disclosed a configuration in which the inclined surface of the sleeve constituting the oil buffer includes a plurality of inclined surfaces each having an inclined angle different from one another. There is also disclosed a technique in which an inclined angle with respect to a central axis of an inclined surface provided immediately on an upper side of the radial bearing portion is made larger than inclined angle(s) of other inclined surface(s) provided on an upper side of the inclined surface such that a capacity of the oil buffer is increased without changing axial lengths of the bearing assembly and the radial bearing portion.

In a fluid dynamic bearing of a motor described in Japanese Unexamined Patent Publication No. 2006-320123, in contrast to the above-described fluid dynamic bearing assembly, an inner peripheral surface of a sleeve is provided with an inclined surface having a small inclined angle immediately on an upper side of a radial bearing portion and other inclined surfaces each having a large inclined angle on an upper side of the inclined surface.

In manufacture of a sleeve of such a fluid dynamic bearing, an inner peripheral surface of the sleeve is formed by cutting a metal member.

When the inner peripheral surface of the sleeve is formed by cutting as described above, an axial position of a boundary between a bearing surface and the inclined surface may be misaligned from a designed position, and a position of an end of a dynamic pressure groove may also be misaligned from the boundary, since the inclined surface is formed by a rough process of relatively poor accuracy. In such a case, an axial length of the dynamic pressure groove differs from a designed value thereof and a pressure for pressing the lubricant into the radial bearing portion and the thrust bearing portion is also made different from a designed value thereof, resulting in the motor being unstably driven.

### SUMMARY OF THE INVENTION

According to preferred embodiments of the present invention, a fluid dynamic bearing includes a sleeve having a bearing hole, a shaft inserted into the bearing hole and rotating relative to the sleeve about a central axis, and a lubricating fluid filled between an inner peripheral surface of the sleeve and an outer peripheral surface of the shaft.

The inner peripheral surface of the sleeve includes a first inclined surface, a second inclined surface, a third inclined surface, and a bearing surface with a dynamic pressure groove formed thereon. The third inclined surface and the bearing surface are formed continuously from each other by a second cutting process of accuracy higher than that of a first cutting process.

The dynamic pressure groove is formed on the bearing surface so as to be in contact with a boundary between the bearing surface and the third inclined surface.

In the fluid dynamic bearing according to the one example of the present invention, it is possible to form accurately in position the boundary between the bearing surface and the inclined surface so as to be in contact with an end of the dynamic pressure groove. Further, a pressure of the lubricating fluid can be stabilized while a motor is being driven.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 shows an internal configuration of a disk drive.

FIG. 2 is a vertical cross sectional view of a motor.

FIG. 3 is a vertical cross sectional view of a sleeve.

FIG. 4 is a bottom view of the sleeve.

FIG. 5 is a vertical cross sectional view partially showing the sleeve and a shaft.

FIG. 6 is a flow chart partially showing a flow of manufacture of the sleeve.

FIG. 7A is a vertical cross sectional view partially showing the sleeve in the course of manufacture at a stage.

FIG. 7B is a vertical cross sectional view partially showing the sleeve in the course of manufacture at a later stage.

### DETAILED DESCRIPTION OF PREFERRED EMBODIMENTS

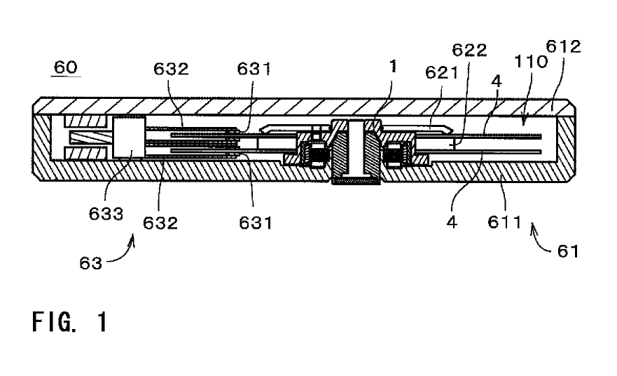

Referring to FIGS. 1 through 7B, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a central axis, and a radial direction indicates a direction perpendicular to the central axis.

A preferred embodiment of the present invention is now described with reference to drawings.

FIG. 1 shows an internal configuration of a disk drive 60 according to a first preferred embodiment of the present invention. The disk drive 60 is a so-called hard disk drive, and includes two disk-shaped storage media (hereinafter, simply referred to as “disks”) 4 each of which can store information therein, an access unit 63, an electric spindle motor 1 (hereinafter, simply referred to as “motor 1”) which can rotates the disks 4, and a housing 61. The access unit 63 writes information on and/or reads information from the disks 4. The housing 61 houses the disks 4, the access unit 63 and the motor 1 in an internal space 110 thereof.

As shown in FIG. 1, the housing 61 includes a first housing member 611 and a second housing member 612. In this preferred embodiment, the first housing member 611 is approximately box-shaped and does not have a lid, and the second housing member 612 is approximately plate-shaped. An upper portion of the first housing member 611 is opened, and the motor 1 and the access unit 63 are attached to an inner bottom surface of the first housing member 611. The second housing member 612 covers the opening of the first housing member 611 so as to form the internal space 110. In the disk drive 60, the housing 61 is formed by joining the second housing member 612 to the first housing member 611, so that the internal space 110 is kept clean with extremely less dust and dirt.

The two disks 4 are disposed on and under a spacer 622 and are mounted on the motor 1 to be fixed to the motor 1 by a clamper 621. The access unit 63 includes magnetic heads 631, arms 632 for respectively supporting the heads 631, and a head moving portion 633. The heads 631 are respectively located close to the disks 4 to read and/or write information on the disks 4. The head moving portion 633 moves the arms 632 so that the heads 631 are moved relative to the disks 4 and the motor 1. With this configuration, each of the heads 631 accesses a required position of each of the disks 4 while being in contact with the spinning disks 4, so as to read and write information.

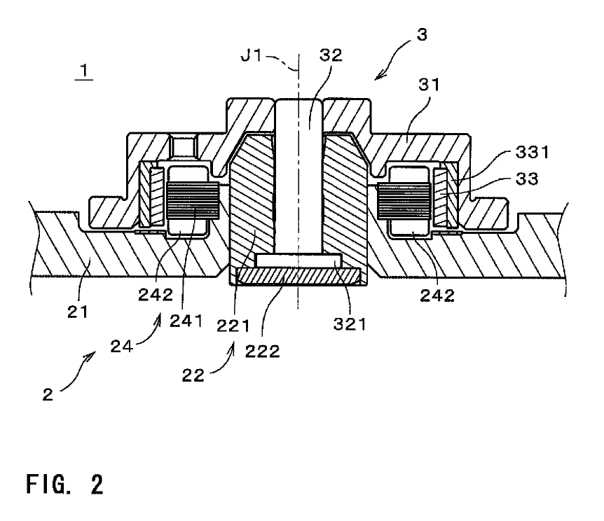

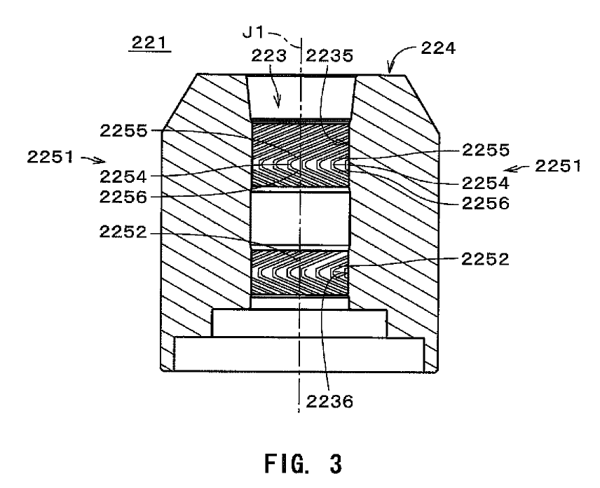

FIG. 2 is shows a configuration of the motor 1 used for rotating the disks 4 in the disk drive 60. FIG. 2 illustrates a cross section including a central axis J1 (also serving as a central axis of a sleeve 221 to be described later) of the motor 1 (same is also true in FIGS. 3, 5, 7A and 7B as to be described later).

As shown in FIG. 2, the motor 1 is of an outer rotor type, and includes a stator unit 2 and a rotor unit 3. The rotor unit 3 is supported in a rotatable manner about the central axis J1 of the motor 1 relative to the stator unit 2 via a fluid dynamic bearing utilizing a fluid dynamic pressure generated by a lubricant serving as a lubricating fluid. In the following description, it is assumed that the rotor unit 3 is located on an upper side and the stator unit 2 is located on a lower side along the central axis J1 for sake of simplicity. However, the central axis J1 is not necessarily aligned to the direction of gravitational force.

The stator unit 2 includes a base plate 21 serving as a base portion for holding respective portions of the stator unit 2, a sleeve portion 22 in a hollow, approximately cylindrical shape with a bottom and centered about the central axis, and a stator 24. The sleeve portion 22 forms a portion of the fluid dynamic bearing for supporting the rotor unit 3 in a rotatable manner. The stator 24 is disposed to surround the sleeve portion 22 and is attached to the base plate 21.

The base plate 21 is a portion of the first housing member 611 (see FIG. 1). In this preferred embodiment, the base plate 21 is formed integrally with other portions of the first housing member 611 by, for example, pressing a plate member. Examples of the material of the base plate 21 are aluminum, aluminum alloy, and (non)magnetic iron metal.

The sleeve portion 22 includes a hollow, approximately cylindrical sleeve 221 and a sealing cap 222 in an approximately circular disk shape. The sleeve 221 has a bearing hole for allowing a shaft 32 of the rotor unit 3 to be inserted thereinto. The sealing cap 222 seals a lower opening of the sleeve 221. A lower portion of the sleeve portion 22 is press fitted into an opening of the base plate 21 so as to be attached to the base plate 21. The stator 24 includes a core 241 formed by a plurality of stacked thin plates, and coils 242 wound around a plurality of teeth of the core 241. In this preferred embodiment, the core 241 is formed by a plurality of silicon steel plates.

The rotor unit 3 includes a rotor hub 31, the shaft 32, and a rotor magnet 33. To the rotor hub 31 is attached the disks 4 (see FIG. 1). Also, the rotor hub 31 holds respective portions of the rotor unit 3. The shaft 32 is centered about the central axis J1 and projects downwards from the rotor hub 31. In this preferred embodiment, the shaft 32 is in the form of an approximately circular column. The rotor magnet 33 is attached to the rotor hub 31 with a substantially annular-shaped yoke 331 interposed therebetween, and is disposed about the central axis J1. The shaft 32 has at a lower end thereof a thrust plate 321. In this preferred embodiment, the thrust plate 321 is in the form of an approximately circular disk. The rotor magnet 33 is a multipolarized magnet in a substantially annular shape, and generates torque about the central axis J1 with respect to the stator 24.

In the motor 1, minute gaps are defined respectively between an inner peripheral surface of the approximately cylindrical sleeve 221 and an outer peripheral surface of the approximately cylindrical shaft 32, between a top surface of the thrust plate 321 and a lower end surface of the sleeve 221 both of which are approximately annular in this preferred embodiment, and between a bottom surface of the thrust plate 321 and a top surface of the sealing cap 222. These gaps provided between the shaft 32 and the sleeve portion 22 are continuously filled with the lubricant to configure a bearing assembly.

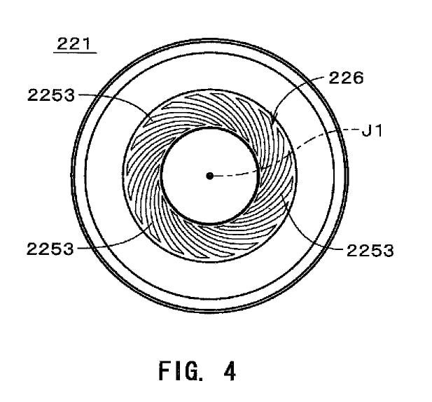

FIG. 3 is an enlarged vertical cross sectional view showing the sleeve 221, and FIG. 4 is a bottom view of the sleeve 221. FIG. 3 also illustrates an inner peripheral surface 223 of the sleeve 221 in the back of the central axis J1. As shown in FIG. 3, the inner peripheral surface 223 of the approximately sleeve 221, which is a plane of rotation about the central axis J1, is provided at an upper portion and a lower portion respectively with upper dynamic pressure grooves 2251 and lower dynamic pressure grooves 2252, both of which are collective grooves for allowing the lubricant to generate a fluid dynamic pressure.

In the motor 1, the outer peripheral surface of the shaft 32 (see FIG. 2) is also provided with a bearing surface facing these dynamic pressure grooves. A radial dynamic pressure bearing portion is defined by the bearing surface of the shaft 32, and an upper bearing surface 2235 and a lower bearing surface 2236 formed respectively with the upper dynamic pressure grooves 2251 and the lower dynamic pressure grooves 2252 on the inner peripheral surface 223 of the sleeve 221.

In this preferred embodiment, the upper dynamic pressure grooves 2251 and the lower dynamic pressure grooves 2252 are formed in herringbone shapes. In the upper dynamic pressure grooves 2251, an upper section 2255 located on an upper side of a bent section 2254 is made longer than a lower section 2256 located on a lower side of the bent section 2254. In other words, the bent section 2254 of the upper dynamic pressure grooves 2251 is positioned below a center in the central axis J1 direction of the upper bearing surface 2235 provided with the upper dynamic pressure grooves 2251.

As described above, the upper section 2255 located on the upper side of the bent section 2254 is made longer in the upper dynamic pressure grooves 2251 such that the lubricant generates a downward fluid dynamic pressure while the rotor unit 3 is being rotated.

As shown in FIG. 4, a lower end surface 226 in an annular shape of the sleeve 221 is formed with lower end dynamic pressure grooves 2253 (dynamic pressure grooves in a spiral shape in this preferred embodiment), which are collective grooves for allowing the lubricant to generate a radially inward pressure while the rotor unit 3 is being rotated. A thrust dynamic pressure bearing portion is configured between the lower end surface 226 and the upper surface of the thrust plate 321 (see FIG. 2) facing the lower end surface 226.

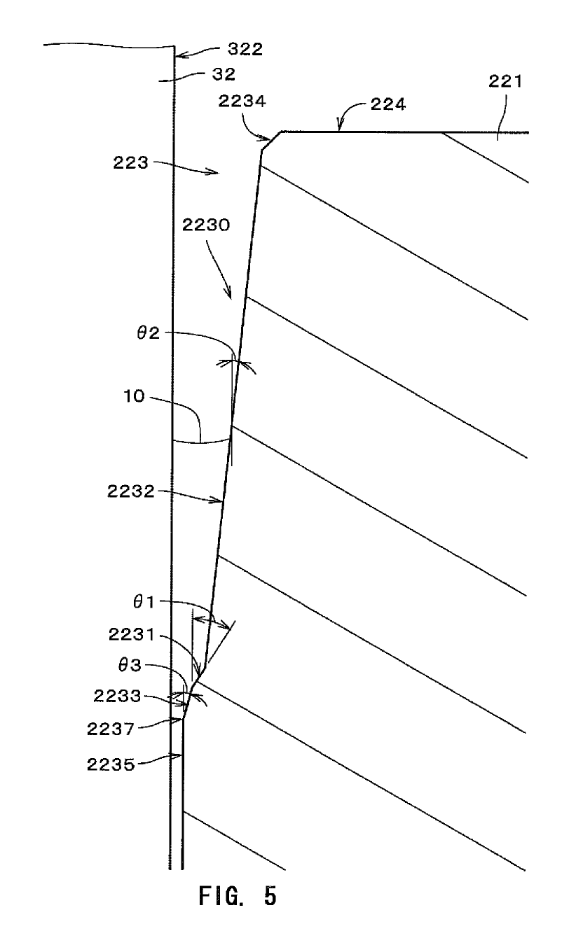

FIG. 5 is an enlarged vertical cross sectional view showing an upper portion of the sleeve 221 together with the shaft 32. FIG. 5 illustrates a portion of the inner peripheral surface 223 of the sleeve 221 and an upper end surface 224 continued from the inner peripheral surface 223 and substantially vertical to the central axis J1.

The inner peripheral surface 223 includes the upper bearing surface 2235 having a cylindrical shape and kept apart from the central axis J1 (see FIG. 3) by a constant distance, an inclined surface portion 2230 having three inclined surfaces inclined with respect to the central axis J1, the inclined surface portion 2230 being located on an upper side of the upper bearing surface 2235, and a connecting inclined surface 2234 connecting the inclined surface portion 2230 and the upper end surface 224. Both of the inclined surface portion 2230 and the connecting inclined surface 2234 are inclined to be opened upwards (that is, to be gradually away from the central axis J1) toward the upper end surface 224. A gap between the inclined surface portion 2230 and an outer peripheral surface 322 of the shaft 32 functions as a tapered seal for preventing outflow of the lubricant and as an oil buffer for retaining the lubricant.

As shown in FIG. 5, the inclined surface portion 2230 includes a first inclined surface 2231, a second inclined surface 2232, and a third inclined surface 2233. A distance between these three inclined surfaces and the central axis J1 in a radial direction with the central axis J1 as a center is gradually increased toward the upper end surface 224. In the inclined surface portion 2230, the third inclined surface 2233, the first inclined surface 2231, and the second inclined surface 2232 are disposed continuously from the upper bearing surface 2235 in this order in an axial direction. A vapor-liquid interface 10 of the lubricant is positioned between the second inclined surface 2232 and the outer peripheral surface 322 of the shaft 32.

In the inclined surface portion 2230, a boundary 2237 between the third inclined surface 2233 and the upper bearing surface 2235 is in contact with upper ends of the upper dynamic pressure grooves 2251 (see FIG. 3) formed on the upper bearing surface 2235. In other words, the third inclined surface 2233 is in contact with the upper ends of the upper dynamic pressure grooves 2251 at the boundary 2237 between the upper bearing surface 2235 and the third inclined surface 2233.

In the inclined surface portion 2230, an inclined angle θ2 and an inclined angle θ3 of the second inclined surface 2232 and the third inclined surface 2233 with respect to the central axis J1 in a cross section including the central axis J1 are made smaller than an inclined angle θ1 of the first inclined surface 2231 with respect to the central axis J1 in the cross section. In FIG. 5, for convenience of illustration, each of the inclined angles θ1, θ2 and θ3 is shown as an angle formed by each of the inclined surfaces and a straight line in parallel with the central axis J1. In the sleeve 221, the inclined angle θ1 of the first inclined surface 2231 is in a range from about 20° to about 90°, and more preferably in a range from about 20° to about 45°. Each of the inclined angle θ2 of the second inclined surface 2232 and the inclined angle θ3 of the third inclined surface 2233 is in a range from about 5° to about 20°. In this preferred embodiment, the inclined angles θ1, θ2 and θ3 are respectively set to 30°, 6°, and 14°.

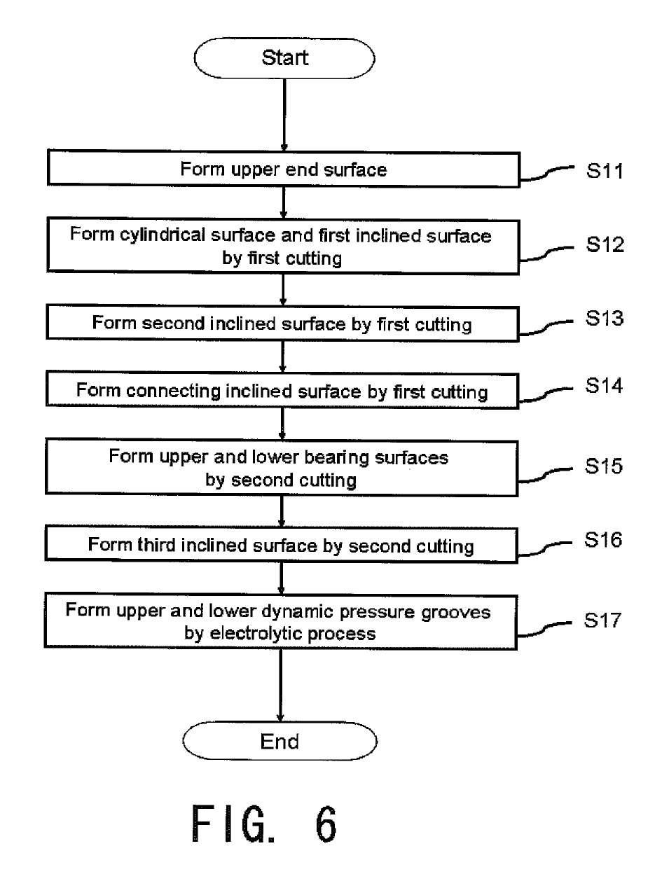

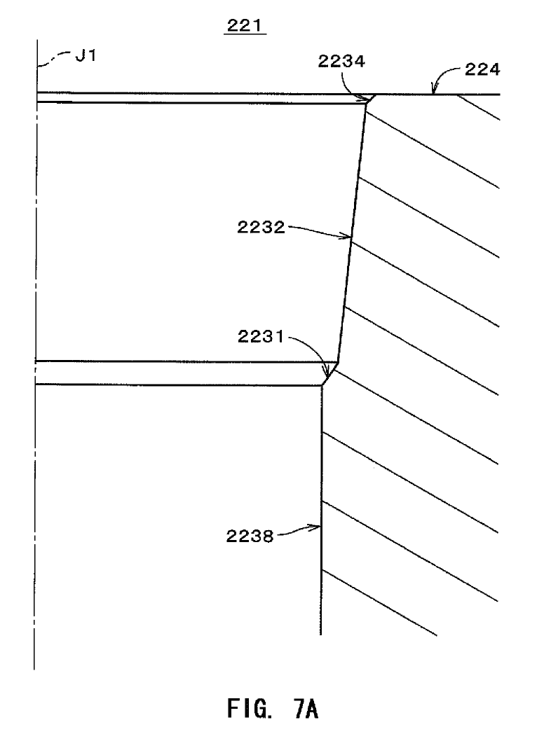

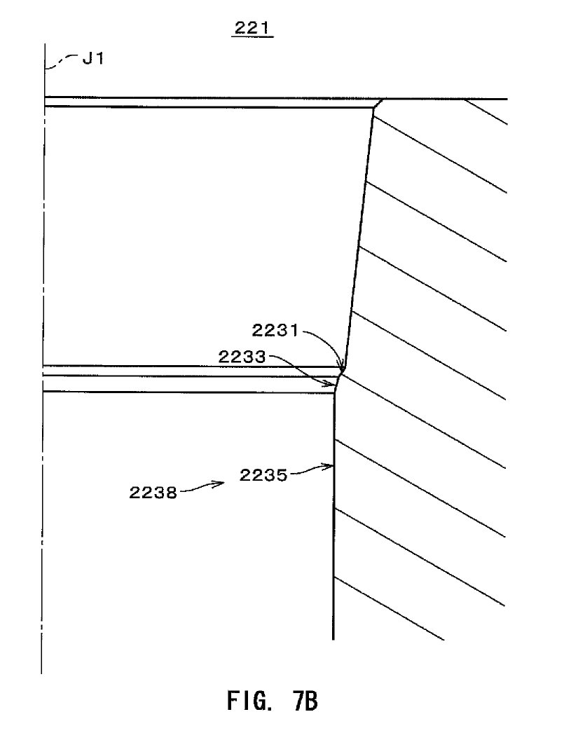

A manufacturing method of the sleeve 221 is described below. FIG. 6 is a flow chart partially showing a flow of manufacture of the sleeve 221, and each of FIGS. 7A and 7B is a vertical cross sectional view partially showing the sleeve 221 in the course of manufacture.

In formation of the sleeve 221, a cutting process is first applied to work in process pieces forming a substantially column shape and held from an outer peripheral side thereof by a chuck of an NC lathe so as to form the upper end surface 224 (Step S11).

Then, after a hole is formed about the central axis J1 by drilling, the cutting process is applied to an inner peripheral surface of the hole. Thereby, as shown in FIG. 7A, a cylindrical surface 2238 is formed, which is to be formed in a later process into the inner peripheral surface 223 having the upper bearing surface 2235 (see FIG. 3) and the like. Further, the first inclined surface 2231 is formed continuously from the cylindrical surface 2238 on an upper side of the cylindrical surface 2238 (Step S12).

Thereafter, the second inclined surface 2232 is formed continuously from the first inclined surface 2231 on the upper end surface 224 side (Step S13). Further, the connecting inclined surface 2234 is formed continuously from the second inclined surface 2232 to the upper end surface 224 on an upper side of the second inclined surface 2232 (Step S14).

A cutting process of accuracy higher than that of the cutting process performed in Steps S12 to S14 is then applied to the cylindrical surface 2238 located on the opposite side of the upper end surface 224 with respect to the first inclined surface 2231. Thereby, as shown in FIG. 7B, the lower bearing surface 2236 (see FIG. 3) and the upper bearing surface 2235 are formed respectively at a lower portion and an upper portion of the cylindrical surface 2238 (Step S15). Thereafter, between the upper bearing surface 2235 and the first inclined surface 2231, the third inclined surface 2233 is formed continuously from the upper bearing surface 2235 in the cylindrical shape (Step S16).

In the following description, in order to distinguish the cutting process firstly performed in steps S12 to S14 from the cutting process secondary performed in steps S15 and S16, the firstly performed cutting process of relatively poor accuracy (so-called a rough process) is referred to as a first cutting process, while the secondly performed cutting process of higher accuracy (so-called a finishing process), which is performed after the first cutting process, is referred to as a second cutting process.

The cutting process of higher accuracy reduces a process variation and a dimensional tolerance in comparison with the cutting process performed in Steps S12 to S14. In the second cutting process, a cutting velocity per unit time by a cutting tool and a processed amount per unit time are smaller than those of the first cutting process. An average value of roughness (Ra) on a center line of a surface (hereinafter, referred to as average surface roughness value) of the cylindrical surface 2238 after being applied with the second cutting process is smaller than that of a surface after being applied with the first cutting process.

Then, electrodes for electrolytic processing are inserted into the sleeve 221 shown in FIG. 3 and are disposed to face the upper bearing surface 2235 and the lower bearing surface 2236 with respect to the lower end surface 226 (see FIG. 4) of the sleeve 221. An electrolytic process is applied respectively to the upper bearing surface 2235 and the lower bearing surface 2236 to form the upper dynamic pressure grooves 2251 on the upper bearing surface 2235 and the lower dynamic pressure grooves 2252 on the lower bearing surface 2236 (Step S17).

The electrode disposed to face the upper bearing surface 2235 has an axial length larger than an axial length of the upper bearing surface 2235. An upper end of the electrode is positioned above the boundary 2237 between the upper bearing surface 2235 and the third inclined surface 2233 shown in FIG. 5. Accordingly, the third inclined surface 2233 located on the upper side of the upper bearing surface 2235 is also formed with grooves by the electrolytic process. However, the grooves formed on the third inclined surface 2233 hardly function as dynamic pressure grooves for allowing the lubricant to generate a fluid dynamic pressure. This is because a radial distance between the third inclined surface 2233 and the outer peripheral surface 322 of the shaft 32 is made larger than a radial distance between the upper bearing surface 2235 and the outer peripheral surface 322 of the shaft 32.

As described above, in manufacture of the sleeve 221 of the fluid dynamic bearing for the motor 1, the inner peripheral surface 223 of the sleeve 221 is formed by cutting. The first inclined surface 2231 and the second inclined surface 2232 are formed by the first cutting process while the upper bearing surface 2235 and the third inclined surface 2233 are then formed by the second cutting process of accuracy higher than the first cutting process, so that it is possible to form accurately in position the boundary 2237 between the upper bearing surface 2235 and the third inclined surface 2233 in contact with the upper ends of the upper dynamic pressure grooves 2251.

Accordingly, it is possible to prevent an axial length of the upper dynamic pressure grooves 2251 from differing from a designed value thereof. That is, the length of the upper dynamic pressure grooves 2251 can be made within an allowable range of the designed value. Then, a fluid dynamic pressure caused by the upper dynamic pressure grooves 2251 can be made equal to a designed value thereof. As a result, the fluid dynamic pressure generated in the bearing assembly to support the rotor unit 3 can be stabilized such that the motor 1 is stably driven. Further, information can be reliably read and written on the disks 4 in the disk drive 60.

Particularly, in the upper dynamic pressure grooves 2251, the upper section 2255 located on the upper side of the bent section 2254 is made longer than the lower section 2256. Thus, the lubricant is allowed to generate a downward fluid dynamic pressure while the rotor unit 3 is being rotated such that the lubricant is pressed into the radial bearing portion and the thrust bearing portion. Accordingly, the pressure of the lubricant in the bearing assembly while the motor 1 is being driven can be further stabilized so as to drive the motor 1 further stably.

In manufacture of the sleeve 221, the first inclined surface 2231 is formed by the first cutting process, and then the third inclined surface 2233 is formed from the upper bearing surface 2235 to the first inclined surface 2231 by the second cutting process so as to have an inclined angle with respect to the central axis J1 smaller than that of the first inclined surface 2231. According to such a method, the third inclined surface 2233 can be reliably continued to the first inclined surface 2231 while the axial length of the third inclined surface 2233 being decreased.

As a result, it is possible to continuously dispose on the upper side of the upper bearing surface 2235 inclined surfaces increasing the radial distance from the central axis J1 as being away from the upper bearing surface 2235, that is, the inclined surfaces capable of forming a tapered seal between the shaft 32 and the inclined surfaces. Therefore, the lubricant can be more reliably sealed in the inclined surface portion 2230.

Furthermore, when the inclined angle with respect to the central axis J1 of the second inclined surface 2232, on which the vapor-liquid interface 10 of the lubricant is positioned, is made relatively small, it is possible to prevent the lubricant from being dispersed over the second inclined surface 2232 while the motor 1 is being driven.

When the inclined angle of the first inclined surface 2231 is made larger than the inclined angle of the second inclined surface 2232, it is possible to increase a capacity of the oil buffer formed between the inclined surface portion 2230 and the outer peripheral surface 322 of the shaft 32 without excessively increasing the axial length of the inclined surface portion 2230. Accordingly, it is possible to reliably prevent leakage of the lubricant as well as shortage in lubricant in the radial bearing portion and the thrust bearing portion, by flexibly responding to variation in amount of the lubricant.

When the inner peripheral surface 223 of the sleeve 221 is formed with the third inclined surface 2233 having the inclined angle of at least 5°, it is possible to clearly form the boundary 2237 between the third inclined surface 2233 and the upper bearing surface 2235. Thus, the grooves formed on the third inclined surface 2233 by the electrolytic process are reliably prevented from functioning as dynamic pressure grooves, and the axial length of the upper dynamic pressure grooves 2251 is prevented from differing from the designed value thereof.

When the third inclined surface 2233 is formed to have the inclined angle of at most 20°, it is possible to increase a design dimension for the inclined angle of the first inclined surface 2231 and to design more freely the sleeve 221 and the motor 1.

In manufacture of the sleeve 221, the upper dynamic pressure grooves 2251 and the lower dynamic pressure grooves 2252 can be formed easily and highly accurately by the electrolytic process in step S17.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

On the inner peripheral surface 223 of the sleeve 221, the third inclined surface 2233 and the first inclined surface 2231 are not necessarily formed continuously from each other. Alternatively, a cylindrical surface apart from the central axis J1 by a constant distance may be formed between the third inclined surface 2233 and the first inclined surface 2231.

In manufacture of the sleeve 221, the upper dynamic pressure grooves 2251 and the lower dynamic pressure grooves 2252 are not necessarily formed by the electrolytic process. Alternatively, the upper dynamic pressure grooves 2251 and the lower dynamic pressure grooves 2252 may be formed by a different process such as cutting.

While the shaft is rotated in the motor according to the above-described embodiment, the motor is not limited thereto but the sleeve may be rotated with respect to the shaft. In such a case, the rotor hub is attached to the outer periphery of the sleeve.

The motor according to the above-described embodiment is not necessarily limited to that of the outer rotor type in which the rotor magnet 33 is disposed outside the stator 24, but may be that of an inner rotor type in which the rotor magnet is disposed inside the stator.

The lubricating fluid of the fluid dynamic bearing is not necessarily limited to the lubricant, but may be vapor such as air.

The motor 1 is not necessarily used as a driving source of the disk drive 60, but may be utilized in various apparatuses other than the disk drive.

Moreover, the first inclined surface and the second inclined surface may be formed by forging, not by the first cutting process. In this case, the bearing surface and the third inclined surface may be formed by the second cutting process.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fluid dynamic bearing for use in a spindle motor, comprising:
a hollow, approximately cylindrical sleeve centered about a central axis;
a shaft centered about the central axis and having an outer peripheral surface facing an inner peripheral surface of the sleeve with a gap therebetween, one of the shaft and the sleeve being rotatable about the central axis relative to the other;
a lubricating fluid held in the gap between the sleeve and the shaft, wherein
the inner peripheral surface of the sleeve includes:
a first inclined surface having a distance from the central axis increasing as the first inclined surface moves axially upward, and forming a first inclination angle with the central axis;
a second inclined surface arranged above and continuous with the first inclined surface, having a distance from the central axis increasing as the second inclined surface moves axially upward, and forming a second inclination angle with the central axis smaller than the first inclination angle;
a bearing surface arranged below the first inclined surface; and
a third inclined surface arranged above and continuous with the bearing surface, having a distance from the central axis increasing as the third inclined surface moves axially upward, and forming a third inclination angle with the central axis smaller than the first inclination angle, and
an interface between the lubricating fluid and air is formed between the second inclined surface of the inner peripheral surface of the sleeve and the outer peripheral surface of the shaft.

2. The fluid dynamic pressure bearing according to claim 1, wherein
the sleeve includes dynamic pressure grooves which generate a hydrodynamic pressure at the bearing surface, and
an upper end of the dynamic pressure grooves is located on a boundary between the bearing surface and the third inclined surface.

3. The fluid dynamic pressure bearing according to claim 2, wherein the dynamic pressure grooves generate the hydrodynamic pressure acting downward from the boundary.

4. The fluid dynamic pressure bearing according to claim 2, wherein the dynamic pressure grooves are formed by an electrolytic process.

5. The fluid dynamic pressure bearing according to claim 1, wherein a lower end of the first inclined surface is continuous with an upper end of the third inclined surface.

6. The fluid dynamic pressure bearing according to claim 1, wherein the second inclination angle of the second inclined surface with respect to the central axis is smaller than the third inclination angle of the third inclined surface with respect to the central axis.

7. The fluid dynamic pressure bearing according to claim 1, wherein the first inclination angle of the first inclined surface with respect to the central axis is in a range from about 20° to about 45°, and the second inclined angle of the second inclined surface and the third inclined angle of the third inclined surface with respect to the central axis are in a range from about 5° to about 20°.

8. The fluid dynamic pressure bearing according to claim 1, wherein the sleeve includes:
an upper end surface continuous with the inner peripheral surface and substantially perpendicular to the central axis; and
a connecting inclined surface connecting the second inclined surface and the upper end surface.

9. The fluid dynamic pressure bearing according to claim 1, wherein average surface roughness values of the bearing surface and the third inclined surface are smaller than that of the second inclined surface.

10. The fluid dynamic pressure bearing according to claim 9, wherein the average surface roughness values of the bearing surface and the third inclined surface are smaller than that of the first inclined surface.

11. An electric motor comprising:
a stationary portion having a stator;
a rotor portion having a rotor magnet facing the stator with a gap therebetween, and being supported in a rotatable manner relative to the stationary portion; and
the fluid dynamic pressure bearing according to claim 1.

12. A disk drive comprising:
a disk-shaped storage medium capable of storing information therein;
the electric motor according to claim 11 arranged to rotate the disk-shaped storage medium;
a head arranged to carry out at least one of reading information from and writing information on the disk-shaped storage medium; and
a head moving portion arranged to move the head relative to the motor and the disk-shaped storage medium.

13. A method for manufacturing a sleeve for use in a fluid dynamic pressure bearing of an electric motor, comprising the steps of:
a) forming an approximately cylindrical inner peripheral surface centered about a center axis;
b) forming a first inclined surface and a second inclined surface above the first inclined surface, a distance between each of the first inclined surface and the second inclined surface and the central axis increasing as it moves axially upward, the first inclined surface forming a first inclination angle with the central axis, and the second inclined surface forming a second inclination angle with the central axis smaller than the first inclination angle; and
c) following a) and b), forming a bearing surface below the first inclined surface and a third inclined surface above the bearing surface, the third inclined surface being continuous with the bearing surface, a distance between the third inclined surface and the central axis increasing as the third inclined surface moves axially upward, the third inclined surface forming a third inclined angle with the central axis smaller than the first inclination angle.

14. The method according to claim 13, wherein in the step b), the first inclined surface and the second inclined surface are formed by first cutting, and
in the step c), the bearing surface and the third inclined surface are formed by second cutting which provides higher precision than that of the first cutting.

15. The method according to claim 14, wherein the first cutting continuously forms the second inclined surface and the first inclined surface, and
the second cutting continuously forms the bearing surface and the third inclined surface.

16. The method according to claim 14, wherein average surface roughness values of the bearing surface and the third inclined surface after the step c) are smaller than that of the second inclined surface after the step b).

17. The method according to claim 16, wherein average surface roughness values of the bearing surface and the third inclined surface after the step c) are smaller than that of the first inclined surface after the step b).

18. The method according to claim 13, wherein average surface roughness values of the bearing surface and the third inclined surface after the step c) are smaller than that of the second inclined surface after the step b).

19. The method according to claim 18, wherein average surface roughness values of the bearing surface and the third inclined surface after the step c) are smaller than that of the first inclined surface after the step b).

20. The method according to claim 13, wherein in the step c), the bearing surface and the third inclined surface are formed by second cutting, and
average surface roughness values of the bearing surface and the third inclined surface after the step c) are smaller than that of the second inclined surface after the step b).

21. The method according to claim 13, further comprising
d) forming dynamic pressure grooves capable of generating a hydrodynamic pressure on the bearing surface, wherein
an upper end of the dynamic pressure grooves is located on a boundary between the bearing surface and the third inclined surface.

22. The method according to claim 21, wherein the dynamic pressure grooves are formed by an electrolytic process.

23. The method according to claim 13, wherein a lower end of the first inclined surface is continuous with an upper end of the third inclined surface.

24. The method according to claim 13, wherein the second inclination angle of the second inclined surface after the step b) is smaller than the third inclination angle of the third inclined surface after the step c).

25. The method according to claim 13, wherein the first inclination angle of the first inclined surface after the step b) is in a range from about 20° to about 45°, and
the second inclination angle of the second inclined surface and the third inclination angle of the third inclined surface are in a range from about 5° to about 20°.

26. The method according to claim 13, further comprising, prior to the step c),
e) forming an upper end surface continuous with the inner peripheral surface and substantially perpendicular to the central axis, and a connecting inclined surface connecting the second inclined surface and the upper end surface.
